(19) United States
(12) Patent Application Publication
(10) Pub. No.: US 2007/0176495 A1
(43) Pub. Date: Aug. 2, 2007

(54) Heat dissipation apparatus for a linear motor

(75) Inventors: Lieh-Feng Huang, Taichung (TW); Chia-Chun Hung, Taichung (TW)

Correspondence Address: CHARLES E. BAXLEY, ESQ., 90 JOHN STREET, THIRD FLOOR, NEW YORK, NY, 10038, US

(73) Assignee: Hiwin Mikrosystem Corp.

(21) Appl. No.: 11/343,614

(22) Filed: Jan. 30, 2006

(51) Int. Cl. H02K 41/00; H02K 3/24

(52) U.S. Cl. 310/12; 310/64

(57) ABSTRACT

A heat dissipation apparatus for a linear motor comprises a motor iron core wound with windings, and a pair of covers and a pair of dissipation mechanisms being arranged at two pairs of opposite sides of the motor iron core, respectively, which is characterized in that: a groove is defined in an inner side of the respective dissipation mechanisms at two opposite sides of the motor iron core for accommodation of heat dissipation medium, such that the coefficient of thermal conductivity of the windings on the motor iron core and the heat dissipation mechanisms are increased, improving the heat dissipation effect.

### BACKGROUND OF THE INVENTION

1. Field of the Invention

The present invention relates to a linear motor mechanism, and more particularly to a heat dissipation apparatus for a linear motor that can improve the heat dissipation effect, and can increase the continuous current and the propelling force of the linear motor.

2. Description of the Prior Art

The existing heat dissipation methods used in a linear motor generally include air cooling, water cooling, external heat sink or external fans, etc. According to our many years experience in the related field, we found that the heat dissipation of the abovementioned heat dissipation methods is relatively slow and can't effectively take the heat source away, wasting a lot of effective power. As a result of that, it is unable to let the linear motor increase its continuous current and to improve the propelling force of the linear motor.

Hence, the conventional design of the heat dissipation structure of the linear motor is really unable to improve economic performance, and developing a solution to the abovementioned shortcomings has become the target of the present invention.

The present invention has arisen to mitigate and/or obviate the afore-described disadvantages.

### SUMMARY OF THE INVENTION

The primary objective of the present invention is to solve the aforesaid problems by providing a heat dissipation apparatus for a linear motor that can increase the continuous current and the propelling force of the linear motor.

To achieve the abovementioned objective, the present invention provides a heat dissipation apparatus for a linear motor comprising a motor iron core wound with windings, and a pair of covers and a pair of dissipation mechanisms being arranged at two pairs of opposite sides of the motor iron core, respectively, which is characterized in that: a groove is defined in an inner side of the respective dissipation mechanisms at two opposite sides of the motor iron core for accommodation of heat dissipation medium, such that the coefficient of thermal conductivity of the windings on the motor iron core and the heat dissipation mechanisms are increased, improving the heat dissipation effect.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an exploded view of a heat dissipation apparatus for a linear motor in accordance with the present invention;

FIG. 2 is an assembly view of the heat dissipation apparatus for a linear motor in accordance with the present invention;

FIG. 3 is an assembly cross sectional view of the heat dissipation apparatus for a linear motor in accordance with the present invention; and

FIG. 4 is an assembly cross sectional view of another embodiment of the present invention.

### DETAILED DESCRIPTION OF THE PREFERRED EMBODIMENTS

The foregoing, and additional objects, features and advantages of the present invention will become apparent from the following detailed description of preferred embodiments thereof, taken in conjunction with the accompanying drawings.

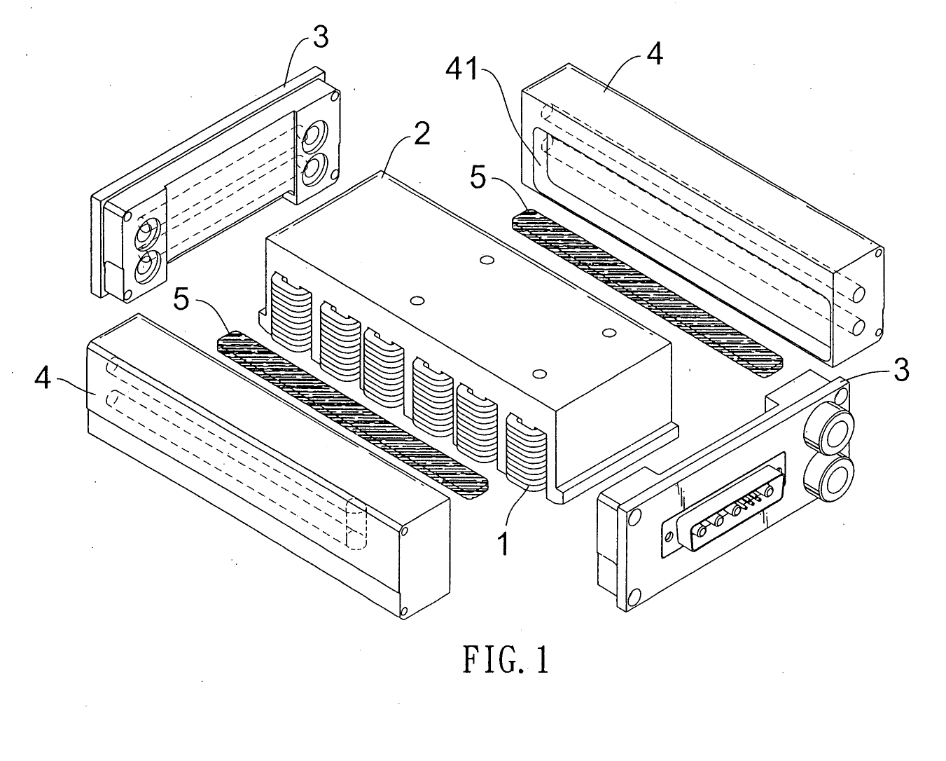

Referring to FIGS. 1-4, the embodiments are shown by way of example and not limitation.

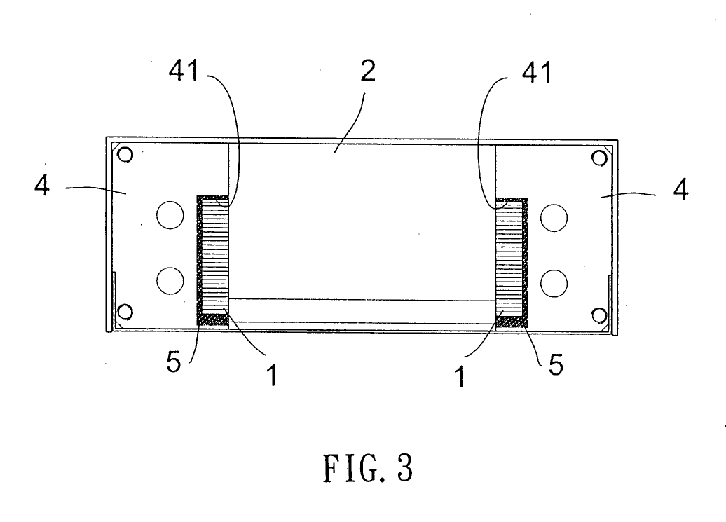

Referring to FIGS. 1 and 3 firstly, a heat dissipation apparatus for a linear motor in accordance with the present invention comprises a motor iron core 2 wound with windings 1, and a pair of covers 3 and a pair of dissipation mechanisms 4 are arranged at two pairs of opposite sides of the motor iron core 2, respectively. The present invention is characterized in that: a groove 41 is defined in the inner side of each of the dissipation mechanisms 4 for accommodation of heat dissipation medium 5 (which is thermal conductive grease for example), such that the coefficient of thermal conductivity of the windings 1 on the motor iron core 2 and that of the heat dissipation mechanisms 4 are increased, thus improving the heat dissipation effect.

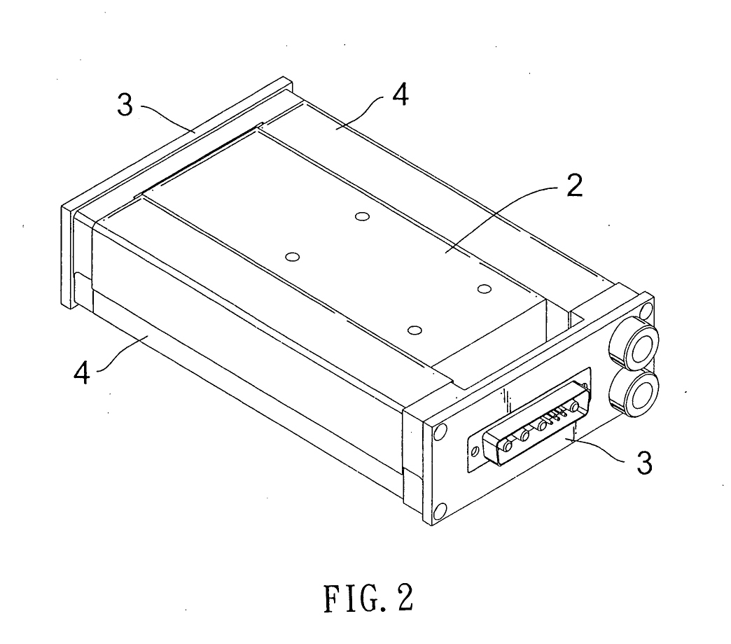

In assembly, the windings 1 are installed on the motor iron core 2, and then the groove 41 in each of the heat dissipation mechanisms 4 at the left and right sides of the motor iron core 2 is filled with the heat dissipation medium 5 (which is thermal conductive grease for example). After that the heat dissipation mechanisms 4 are installed on the motor iron core 2, ensuring that the heat dissipation medium 5 closely contacts the windings 1. Finally, the covers 3 at the front and rear sides of the motor iron core 2 are fixed on the heat dissipation mechanism 4 by screws. The finished assembly of the heat dissipation apparatus is shown in FIG. 2.

It will be noted that we tested two motors, one with and one without the heat dissipation medium, and their results are shown in table 1 and table 2. It is understood from the data shown in the tables that the propelling force of the linear motor will be increased noticeably after using the heat dissipation medium, the work efficiency and the service life of the motor will also be improved.

TABLE 1

| | motor | | |
|---|---|---|---|
| | | Motor 1 (with heat dissipation | |
| item | Motor 1 | medium) | remarks |
| Force constant | 24.2 | 23.3 | |
| (N/A) | | | |
| Temperature rise | 6.2 | 6.8 | |
| balanced current | | | |
| (100° C./A) | | | |
| Water cooling | 7.8 | 11.6 | |
| Temperature rise | | | |
| balanced | | | |
| current(100° C./A) | | | |
| Continuous force | 150 | 158.4 | |
| (N) | | | |
| Water cooling | 188.8 | 270.3 | |
| Continuous force | | | |
| (N) | | | |

TABLE 2

| | motor | | |
|---|---|---|---|
| | | Motor 2 (with heat dissipation | |
| item | Motor 2 | medium) | remarks |
| Force constant | 30.3 | 29.9 | |
| (N/A) | | | |
| Temperature rise | 4.8 | 6.4 | |
| balanced current | | | |
| (100° C./A) | | | |
| Water cooling | 7.4 | 12 | |
| Temperature rise | | | |
| balanced | | | |
| current(100° C./A) | | | |
| Continuous force | 145.4 | 191.2 | |
| (N) | | | |
| Water cooling | 236.3 | 358.8 | |
| Continuous force | | | |
| (N) | | | |

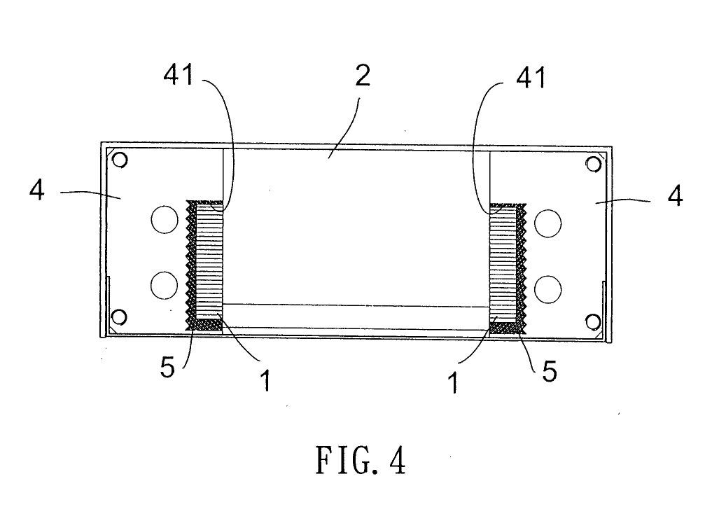

Certainly, the present invention has many embodiments and they vary only in detail. With reference to FIG. 4, which shows another embodiment of the present 5 invention and which is an assembly cross sectional view of the another embodiment of the present invention, wherein the groove 41 in the inner surface of each of the heat dissipation mechanisms 4 at the two opposite sides of the motor iron core 2 is designed to have a non-flat bottom (it is a saw tooth surface in this embodiment, for example), so that the heat dissipation area is increased and the dissipation effect is accordingly improved.

Hence, as stated above, the present invention has the following advantages:

1, it helps heat dissipation, and can increase the continuous current and the propelling force of the linear motor.

2, easily assembled and economic.

3, service life is prolonged and production cost is saved.

While we have shown and described various embodiments in accordance with the present invention, it should be clear to those skilled in the art that further embodiments may be made without departing from the scope of the present invention.

What is claimed is:

1. A heat dissipation apparatus for a linear motor comprising a motor iron core wound with windings, and a pair of covers and a pair of dissipation mechanisms being arranged at two pairs of opposite sides of the motor iron core, respectively, characterized in that:
a groove is defined in an inner side of the respective dissipation mechanisms at two opposite sides of the motor iron core for accommodation of heat dissipation medium, such that the coefficient of thermal conductivity of the windings on the motor iron core and the heat dissipation mechanisms are increased, improving the heat dissipation effect.

2. The heat dissipation apparatus for a linear motor as claimed in claim 1, wherein the heat dissipation medium in the groove in the inner side of the respective dissipation mechanisms at two opposite sides of the motor iron core is a heat dissipation grease.

3. The heat dissipation apparatus for a linear motor as claimed in claim 1, wherein the groove in the inner side of the respective dissipation mechanisms at two opposite sides of the motor iron core is designed to have a non-flat surface, so that its heat dissipation area is increased and its dissipation effect is accordingly improved.
